(19) United States
(12) Patent Application Publication
(10) Pub. No.: US 2005/0137917 A1
(43) Pub. Date: Jun. 23, 2005

(54) Disambiguating travel schedules around midnight

(75) Inventors: Ciprian Agapi, Lake Worth, FL (US); James R. Lewis, Delray Beach, FL (US); Vanessa V. Michelini, Boca Raton, FL (US); Clifford J. Strohofer, Delray Beach, FL (US)

Correspondence Address: Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/744,303

(22) Filed: Dec. 22, 2003

(51) Int. Cl. G06F 17/60

(52) U.S. Cl. 705/6; 705/1

(57) ABSTRACT

The present invention addresses problems associated with accessing and using automated systems for scheduled travel events and provides a method and system for communicating information to a user interacting with an automated system for accessing travel schedule data. In a first embodiment of the present invention, a user request can be processed for an event scheduled on an automated system. An occurrence time for the scheduled event can then be loaded. If the occurrence time is within a preconfigured time interval including midnight, a disambiguation process can be triggered for the scheduled event. The scheduled event can be an airline flight and the occurrence time can be an arrival or departure time. The disambiguation process can include prompting a user with a disambiguation message, wherein the disambiguation message makes reference to either an arrival date for the airline flight or a departure date for the airline flight.

### BACKGROUND OF THE INVENTION

1. Statement of the Technical Field

The present invention relates to the field of automated travel and reservations systems and more particularly to a method for disambiguating travel events scheduled around midnight.

2. Description of the Related Art

Automated travel reservations systems are fast replacing older, more traditional methods of booking travel. Users can easily and quickly connect to an automated system over a communications network, such as the Internet, to view travel schedules, make reservations, and book or purchase an airline flight, car rental reservation, hotel room, and the like.

A common problem arises when travel is scheduled around midnight. Most “travel events”, such as the departure or arrival time of an airplane, train, or ferry, require that a person be available or arrive for the scheduled event some time prior to the scheduled event. In the case of international airline flights, travelers must generally report to an airport two to three hours prior to a scheduled departure. When the scheduled event occurs shortly after midnight, the date at which the traveler must “report” and the date at which the travel actually occurs is different. For example, if a flight were scheduled at 12:15 AM on a Friday, the traveler would have to report to the airport on the Thursday before the scheduled flight. Thus, a date change is usually an issue for travel that occurs around midnight.

With automated systems, the date change can create ambiguities and easily cause a user of the system to make a mistake as to the actual date of travel. FIG. 1 illustrates a common occurrence that leads to ambiguity and causes travelers to mistake dates and times for travel. For example, a user 1 could access an automated travel system 5 over a network 8, intending to book a flight departing on the evening of Friday and arriving some time after midnight, on Saturday. However the user might only specify the departure date for the flight: Friday. The system could then find a flight departing at 12:15 AM on Friday. Upon seeing or hearing the 12:15 departure time, and knowing that to catch such a flight the user would have to arrive at the airport around 10:00 PM, the user could make the mistake of thinking that the flight was departing late Friday evening, whereas, in fact, the flight was departing much earlier.

Another scenario which could arise where a user could wish to check the arrival time of a flight, which departed at 12:30 AM on Day 2 and is scheduled to arrive at 11:00 AM on Day 2. The user, thinking that travel was to occur from the late evening of Day 1 to the morning of Day 2, could provide the system only with the departure date 1. The system would then provide the user with the arrival time of the flight departing at 12:30 AM on Day 1, instead of Day 2.

It would be desirable therefore, to provide a method and system for communicating information to a user interacting with an automated system for accessing schedule data, such as on a travel reservations system, which solves the problems of confusion and mistake of times and dates that commonly arise when the times occur around midnight.

### SUMMARY OF THE INVENTION

The present invention addresses the deficiencies of the art in respect to accessing and using automated systems for scheduled events and provides a novel and non-obvious method and system for communicating information to a user interacting with an automated system for accessing travel schedule data.

In a first embodiment of the present invention, a user request can be processed for an event scheduled on an automated system. An occurrence time for the scheduled event can then be loaded. If the occurrence time is within a preconfigured time interval including midnight, a disambiguation process can be triggered for the scheduled event.

Systems consistent with the present invention include a disambiguation tool for communicating information to a user interacting with an automated system for accessing schedule data. The tool can be configured to process a user request for a scheduled event and can load an occurrence time for the scheduled event. The tool can be further configured to trigger a disambiguation process for the scheduled event if the occurrence time is within a preconfigured time interval including midnight.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is conceptual illustration of the problem addressed by the present invention;

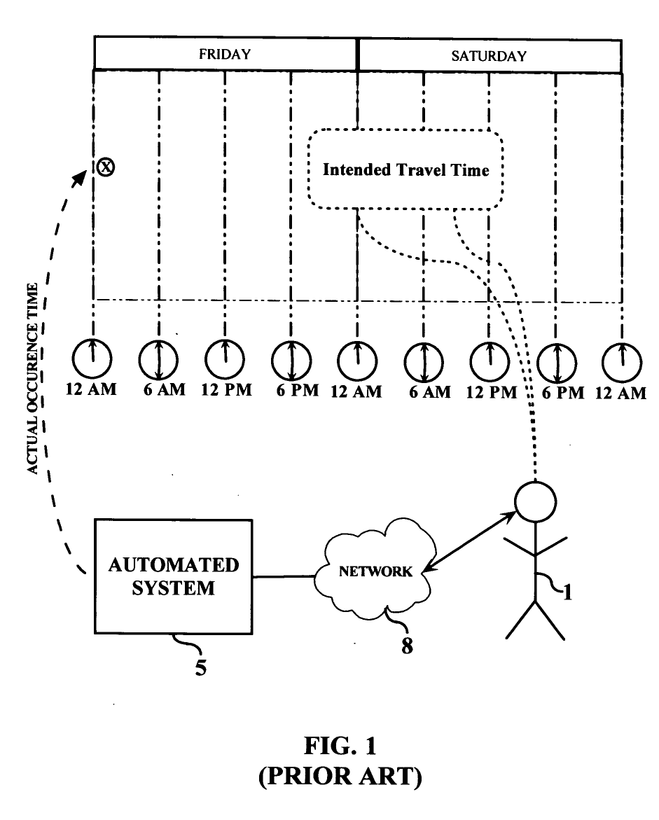

FIG. 2 is a schematic illustration of a system configured for disambiguating midnight reservations; and

FIG. 3 is a flowchart of a process for disambiguation arranged in accordance with the principles of the present invention.

### DETAILED DESCRIPTION OF THE PREFERRED EMBODIMENTS

The present invention is a method and system for disambiguating travel events that occur around midnight. The invention provides for an automated system to receive a user request for a scheduled travel event. If the occurrence time of the requested travel event occurs around midnight, then the automated system can prompt the user with a disambiguation message. In the disambiguation message, reference can be made to the actual dates of the travel events, so as to remove any ambiguity that may arise when events occur near or through midnight.

As used herein, an “automated system for accessing schedule data” can be any automated system having logic to store, search, retrieve, or communicate one or more “scheduled events.” The automated system could be implemented via the web, through a telephony network, or any other means for managing data and communicating such data with a user. Also as used herein, a “scheduled event” can be any event or transaction that either: (i) occurs regularly or follows a schedule, or (ii) is arranged to occur at a particular, though not necessarily pre-determined, time. The scheduled event can be an airline flight departure, the arrival of a train, or an automobile rental pick-up.

However, the actual “occurrence time” of the scheduled event need not coincide with any particular time the event was scheduled to occur. The “occurrence time” can be earlier or later than the scheduled time. As most travelers know well, this is commonly the case for airline travel, where departures and arrivals do not always occur exactly at the time they are scheduled. Therefore, as used herein, the “occurrence time” for a scheduled event can be any time of day, which an automated system can read or process, that has some relationship to a scheduled event.

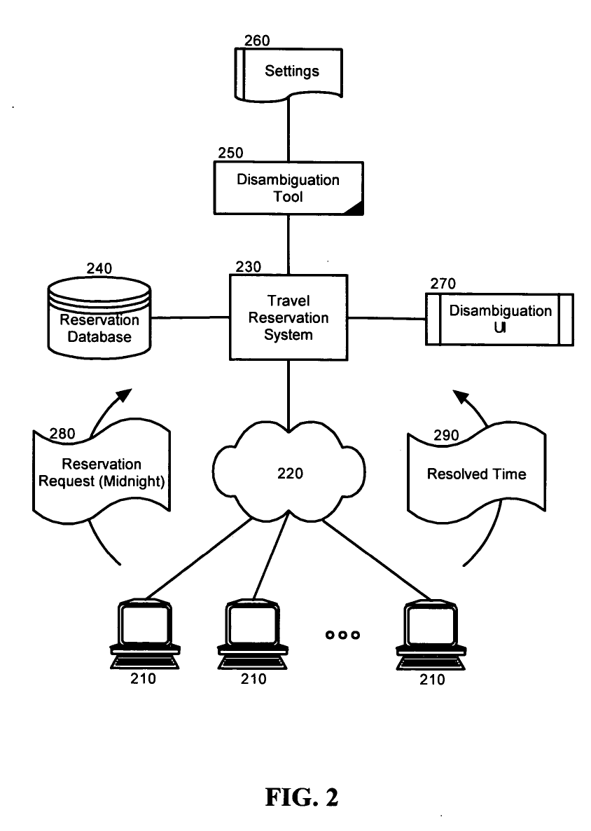

FIG. 2 is a schematic illustration of a system configured for disambiguating midnight reservations. The system of the present invention can include a travel reservation system 230 coupled to a plurality of travel reservation clients 210 over a computer communications network 220. The travel reservation system 230 can be configured to process reservation requests based upon reservation availability information stored in a reservation database 240. Notably, it will be understood by the skilled artisan that the invention is not limited strictly to the use of the travel reservation system 230 over a computer communications network and other modes of access are contemplated herein, including telephonic access through a telephony gateway into the travel reservation system 230.

In accordance with the present invention, a disambiguation tool 250 can be coupled to the travel reservation system 230. The disambiguation tool 250 can include a configuration for detecting reservation requests around midnight 280. In particular, the disambiguation tool 250 can include programming for detecting a request for a reservation in proximity to midnight so as to create an ambiguity as to the requested date of the reservation. To that end, a proximity range can be established, for instance fifteen minutes about either side of midnight, two hours about either side of midnight, or five hours about either side of midnight, though the invention is not so limited to any particular range. Preferably, the particular range of proximity can be established through tool settings 260.

In any event, a disambiguation user interface 270 can be provided in concert with the disambiguation tool 250 responsive to the detection of an ambiguous midnight reservation request 280. The disambiguation user interface 270 can provide a means to send a message or communication to a client 210 that disambiguates the reservation request around midnight 280. The disambiguation user interface 270 can also provide a means through which a requesting client 210 can specify with particularity whether the reservation request relates to a day prior to midnight, or a day past midnight. Based upon the disambiguation user interface 270, a resolved time 290 can be provided to the travel reservation system 230 for further processing.

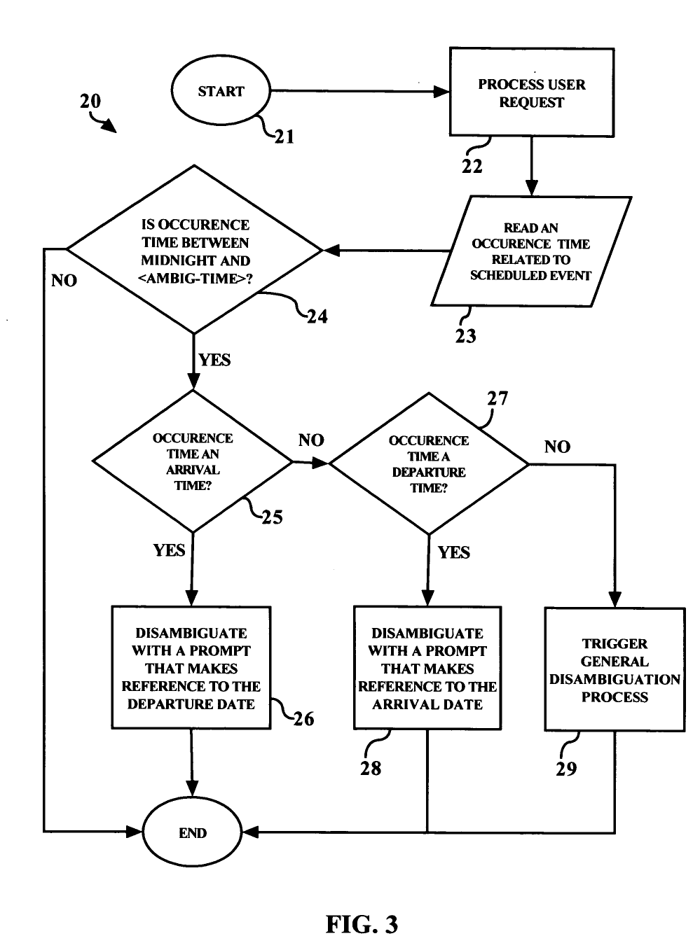

FIG. 3 is a flowchart of a process 20 for disambiguation arranged in accordance with the principles of the present invention. Starting at step 21, an automated system for accessing schedule data can process a user request, in step 22, for a particular scheduled event, such as an airline flight arrival. Next, at step 23, the system can read the occurrence time for the scheduled event. Then, in step 24, the system can compare the occurrence time with midnight. In making this comparison, the system can determine whether or not the occurrence time falls between midnight and some reference time referred to herein as: “<AMBIG-TIME>”. <AMBIG-TIME> can be any time of day that is pre-configured in the system, and can extend through an interval that includes midnight. The length of the interval can be, for example, between two to five hours.

If the occurrence time does not lie between midnight and <AMBIG-TIME>, then the process ends. If however, the occurrence time does lie between midnight and <AMBIG-TIME>, then the process proceeds to step 25, where it can first determine if the occurrence time is an arrival time for an event or transaction that involves both the departure and arrival of an entity. If so, the process can provide a disambiguation message to the user in step 26, which makes specific reference to one or more dates of departure for the event or transaction. If the arrival time was for the arrival of a particular airline flight, the disambiguation message prompted to the user in step 26 could include a choice to select from two different dates of departure for the same scheduled airline flight event. The user would then become aware of any possibly ambiguity.

Alternatively, if in step 25 it is determined that the occurrence time is not an arrival time, the process proceeds to step 27, where it can determine if the occurrence time is a departure time for an event or transaction that involves both the departure and arrival of an entity. If so, the process can provide a disambiguation message to the user in step 28, which makes specific reference to one or more dates of arrival for the event or transaction. If the departure time was for the departure of a particular airline flight, the disambiguation message prompted to the user in step 28 could include a choice to select from two different dates of arrival for the same scheduled airline flight event. The user would then become aware of any possibly ambiguity.

If in step 27 it is determined that the occurrence time is not a departure time, the process can nevertheless proceed to provide a general disambiguation message by triggering a general disambiguation process. Such a process is defined as any communication by the system to a user which provides date and/or time data related to the scheduled event requested by user in step 22 that would tend to remove the ambiguity surrounding occurrence times around midnight. The process could include repeated prompts to a user, asking the user confirm his or her selection, and could specifically make reference to the occurrence time around midnight by making the time prominent so as to be likely to be perceived by the user.

Both the general disambiguation process in step 29 and the disambiguation messages conveyed in steps 26 and 28 can involve any means or modality of communication, including visual, aural, textual, graphic, or some other human-readable mode of communication.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A method of communicating information to a user interacting with an automated system for accessing schedule data, comprising the steps of:
processing a user request for a scheduled event;
loading an occurrence time for the scheduled event;
triggering a disambiguation process for the scheduled event if the occurrence time is within a preconfigured time interval including midnight.

2. The method of claim 1,
wherein the scheduled event is an airline flight.

3. The method of claim 2,
wherein the occurrence time is selected from a group consisting of a departure time for the airline flight and an arrival time for the airline flight.

4. The method of claim 3, further comprising:
prompting the user with a disambiguation message during the disambiguation process, and
referencing one or more dates for the airline flight in the disambiguation message, the dates being selected from a group consisting of an arrival date for the airline flight and a departure date for the airline flight.

5. The method of claim 1,
wherein the preconfigured time interval is a length of two to five hours.

6. A machine readable storage having stored thereon a computer program for communicating information to a user interacting with an automated system for accessing travel schedule data, said computer program comprising a routine set of instructions for causing the machine to perform the steps of
processing a user request for a scheduled event;
loading an occurrence time for the scheduled event;
triggering a disambiguation process for the scheduled event if the occurrence time is within a preconfigured time interval including midnight.

7. The machine readable storage of claim 6,
wherein the scheduled event is an airline flight.

8. The machine readable storage of claim 7,
wherein the occurrence time is selected from a group consisting of a departure time for the airline flight and an arrival time for the airline flight.

9. The machine readable storage of claim 8, and further causing the machine to perform the steps of:
prompting the user with a disambiguation message during the disambiguation process, and
referencing one or more dates for the airline flight in the disambiguation message, the dates being selected from a group consisting of an arrival date for the airline flight and a departure date for the airline flight.

10. The machine readable storage of claim 7,
wherein the preconfigured time interval is a length of two to five hours.

11. A disambiguation tool for communicating information to a user interacting with an automated tool for accessing schedule data, the tool being configured to process a user request for a scheduled event and to load an occurrence time for the scheduled event, the tool being further configured to trigger a disambiguation process for the scheduled event if the occurrence time is within a preconfigured time interval including midnight.

12. The disambiguation tool of claim 11,
wherein the scheduled event is an airline flight.

13. The disambiguation tool of claim 12,
wherein the occurrence time is selected from a group consisting of a departure time for the airline flight and an arrival time for the airline flight.

14. The disambiguation tool of claim 13,
wherein the disambiguation process includes prompting the user with a disambiguation message, the disambiguation message including one or more dates for the airline flight, the dates being selected from a group consisting of an arrival date for the airline flight and a departure date for the airline flight.

15. The disambiguation tool of claim 11,
wherein the preconfigured time interval is a length of two to five hours.

16. A system for disambiguating midnight reservations, comprising a disambiguation tool coupled to a travel reservation system and configured to disambiguate midnight reservation requests.

17. The system of claim 16, further comprising a proximity setting disposed within disambiguation tool settings for said disambiguation tool.
